(19) United States
(12) Patent Application Publication
(10) Pub. No.: US 2003/0006986 A1
(43) Pub. Date: Jan. 9, 2003

(54) Method and apparatus for demonstrating mathematical relationships

(76) Inventors: Thomas P Dick, Corvallis, OR (US); Nigel Fraser Hooke, Mt. Waverley (AU); Mark Howell, Vermont South (AU); Charles M. Patton, Eugene, OR (US); Gregory Thorne Springer, Dallas, TX (US); Carla Randall, West Linn, OR (US)

Correspondence Address: HEWLETT-PACKARD COMPANY, Intellectual Property Administration, P.O. Box 272400, Fort Collins, CO, 80527-2400, US

(21) Appl. No.: 09/832,515

(22) Filed: Apr. 10, 2001

(51) Int. Cl. G06T 11/20

(52) U.S. Cl. 345/440

(57) ABSTRACT

A hand held computer device for teaching mathematical inter-relationships The device interactively and directly demonstrates the inter-relationship between a graphical representation of a mathematical relation and other representations of the mathematical relation such as an equation or table of values as a user manipulates a graph of the mathematical relation via a stylus/touch screen graphical user interface of the device. Such manipulation simultaneously correspondingly amends another displayed form of the mathematical relation.

### FIELD OF INVENTION

This invention relates to a method and apparatus for interactively demonstrating an interrelationship between different representations of a mathematical relationship. It relates particularly but not exclusively to a programmable hand held computer device.

### BACKGROUND OF THE INVENTION

A fundamental mathematical concept which is of importance to an understanding of mathematics is cognisance of the interrelationship between the various representational forms of a mathematical relationship (for example, a graphical representation and a corresponding mathematical equation).

Fundamental to the understanding of the relationship which exists between the various representational forms is the ability to interpret the effect of modification of one form on a second form. For example, how does changing the value of a variable in a mathematical equation affect a corresponding graphical representation? Similarly, how does changing a characteristic of a graph affect a corresponding mathematical equation?

In the teaching of mathematics, various techniques are available for demonstrating the interrelationship between the different forms of a mathematical relationship. However, it appears that the known techniques have limitations which reduce the teaching effectiveness and may, in fact, create a negative learning environment.

Traditional techniques have relied on the ability of a teacher to convey the necessary mathematical principles using hand drawn sketches and mathematical equations to assist in the explanation of the relationship between a mathematical equation and the corresponding graphical representation. Here, the hand drawn sketches and equations are manually amended so as to provide a practical demonstration of the interrelationship. However, the ability to manually amend a particular graph in accordance with an alteration to an equation is largely dependent upon the type and complexity of the equation. Hence, mathematical relationships of even moderate complexity (for example, an elliptical function) and the interrelationship between different forms of the relationship (for example the graphical and equation forms) may be difficult to construct and thus convey. Furthermore, this technique is susceptible to errors and inaccuracies which may be introduced by crude approximations, both during an analytical process which may be used to determine the effect of modification of one form on the other, and in the presentation of the mathematical representations themselves. Another problem which may arise in the application of this type of technique is that of efficiency. This technique may not be not an effective technique for conveying the appropriate principles to a student since the nature of the interaction between a student and the manipulation process is indirect. Here, since the alteration and amending process is performed by the teacher, and not the student, the student is only indirectly involved. Even if a student performs the alteration/amending functions, there is no “immediacy” involved, for example, the effect of an alteration of one representational form of the relationship on another form usually requires intermediate steps of calculation and then manual amendment. Such an indirect interaction may inhibit the ability of the student to conceptualise the appropriate mathematical principles.

Recently, with the widespread use of computers as an educational tool, teaching techniques which utilise a computerised approach have become increasingly popular.

An object of the present invention is to provide a method and apparatus, realisable in a computerised teaching aid, for directly demonstrating the interrelationship between a graphical representation and other representations of a mathematical relationship.

### SUMMARY OF THE INVENTION

According to a first aspect of the present invention, there is provided an interactive method for demonstrating an interrelationship between different representations of a mathematical relationship, including the steps of:

(a) defining a mathematical equation;

(b) simultaneously displaying at least two of multiple representations of the defined mathematical equation, wherein the available types of multiple representations include a graphical representation in the form of a graph, a numerical representation in the form of a table of values, and a symbolic representation in the form of an equation expressed in terms of standard mathematical nomenclature, wherein one of the displayed representations is the graphical representation;

(c) manipulating the graphical representation; and

(d) processing the manipulation to substantially simultaneously and correspondingly update the other displayed representation of the mathematical relationship in accordance with the manipulation of the graphical representation; whereby a user of the method is able to substantially immediately observe the effect of changes made to the graphical representation via its manipulation on the other of the at least two displayed representations.

In this description and the appended claims, the word “manipulate” and its derivatives such as “manipulating” and “manipulation” are to be understood as involving a direct interaction between a user and the graphical representation which results in modification to a continuum of values which characterise the graph, that is, the manipulation involves the whole of a graphical trace as such.

The types of manipulation mechanisms available for manipulating the graphical representation of the mathematical relation include:

(a) translating the graph with respect to a set of coordinate axes; and

(b) dilating the graph with respect to a set of coordinate axes.

Preferably the step of defining a mathematical equation includes selecting a mathematical equation from a list of predefined mathematical equations. Preferably the types of predefined mathematical equations include equations selected from one or more of:

(a) linear mathematical relations;

(b) polynomial mathematical relations;

(c) exponential mathematical relations;

(d) logarithmic mathematical relations;

(e) power mathematical relations;

(f) trigonometric mathematical relations; and

(g) conic section mathematical relations.

In one particularly preferred form of the present invention, the list of predefined mathematical equations include at least two equations selected from:

(a) a linear mathematical equation described by y=m(x−h)+k;

(b) a quadratic mathematical equation described by y=a(x−h)²+k;

(c) a circular mathematical equation described by (x−h)²30 r²;

(d) an elliptical mathematical equation described by

$$\frac{{( x - h )}^{2}}{{a}^{2}} + \frac{{( y - k )}^{2}}{{b}^{2}} = 1 ;$$

(e) a hyperbolic mathematical equation described by

$$\frac{{( x - h )}^{2}}{{a}^{2}} - \frac{{( y - k )}^{2}}{{b}^{2}} = 1 ;$$

(f) a hyperbolic mathematical equation described by

$$\frac{{( y - k )}^{2}}{{b}^{2}} - \frac{{( x - h )}^{2}}{{a}^{2}} = 1 ;$$

(g) a parabolic mathematical equation described by y=m(x−h)²+k;

(h) a parabolic mathematical equation described by (y−k²)=c(x−h)

(i) a general exponential mathematical equation described by y=ba^{x}+k;

(j) a natural exponential mathematical equation described by y=be^{ax}+k;

(k) a logarithmic mathematical equation of the form y=b 1n(a(x−h))+k;

(l) a power mathematical equation described by y=a(x−h)^{r}+k;

(m) a sine mathematical equation described by y=bSin(a(x−h))+k; and

(n) a cosine mathematical equation described by y=bCos(a(x−h))+k;

where x and y are variable parameters and a, b, m, h, k and r are parameters according to standard mathematical nomenclature, the numerical values for which included in a particular predefined mathematical relation are user definable.

In the preferred form of the present invention the inventive method is performed using a programmed hand held computer in combination with a stylus device.

In a second aspect of the present invention, there is provided an interactive method for demonstrating an interrelationship between representations of a mathematical relationship, one of which representations is a graphical representation of the relationship relative to co-ordinate axes, the method including:

(a) simultaneously displaying on a visual display a mathematical relation in the form of the graphical representation and in another format being either an algebraic formula or a tabulated set of data which describes the graph or both;

(b) locating a stylus on the graphical representation on a position sensing screen associated with the visual display and a processor for the position sensing device to sense stylus position and provide stylus position data to the processor;

(c) moving the stylus over the position sensing screen for the processor to process changing stylus position data and manipulate the displayed graphical representation to change its shape or position relative to the co-ordinate axes in accordance with the motion of the stylus over the position sensing screen;

(d) wherein displayed information in said another format is substantially simultaneously and correspondingly changed to continually describe the graph as it is manipulated;

whereby a user of the method is able to substantially immediately observe the effect of changes made to the graphical representation via its manipulation on said another of the displayed representations.

In a third aspect of the present invention, there is provided apparatus for interactively demonstrating an interrelationship between different representations of a mathematical relationship, the apparatus including

a visual display device and a position sensitive touch screen associated with the visual display device, a processor operatively linked with the visual display device and the touch screen, and a memory for storing application software, data and visual display information for the processor, visual display device and touch screen;

the visual display device and position sensitive touch screen providing for definition by use of a stylus of a mathematical equation;

wherein the visual display device simultaneously displays at least two of multiple possible representations of the defined mathematical equation, the multiple possible representations including a graphical representation in the form of a graph, a numerical representation in the form of a table of relation values, and a symbolic representation in the form of an equation expressed in terms of standard mathematical nomenclature,

and wherein the graphical representation is selectable for display as one of said at least two displayed representations;

wherein a stylus is positionable on the touch screen on the graphical representation and movable over the touch screen to generate changing position data, the apparatus being responsive to said changing position data for the visual display device to display in real time a manipulation of the graphical representation corresponding to the movement of the stylus;

and wherein the apparatus is also responsive to said changing position data to substantially simultaneously and correspondingly update the other displayed representation of the mathematical relationship in accordance with the manipulation of the graphical representation whereby a user is able to substantially immediately observe the effect of changes made to the graphical representation via its manipulation on the other of the at least two displayed representations.

Preferably the visual display device and position sensitive touch screen provide for selection of a mathematical equation from a list of predefined mathematical equations stored in the memory whereby the mathematical equation is definable.

Preferably there is provided a hand held computer device for demonstrating an interrelationship between different representations of a mathematical relationship, including

(a) a visual display unit for displaying at least two of multiple representations of a mathematical relationship, wherein the available representations include:

(i) a graphical representation;

(ii) a numerical representation in the form of tabulated data; and

(iii) a symbolic representation in the form of a mathematical equation;

(a) a memory for storing application software, data, and visual display information;

(b) a stylus;

(c) a position sensing touch screen associated with the visual display unit; and

(d) a processor coupled to the visual display unit, memory, and position sensing touch screen for updating multiple representations of the mathematical relationship according to a manipulation of a graphical representation displayed on the visual display unit, wherein the manipulation of the graphical representation occurs in response to a motion of the stylus on the position sensing touch screen;

whereby a user of the device is able to substantially immediately observe the effect of changes made to the graphical representation via its manipulation on the other of the at least two displayed representations.

The invention will hereafter be described in greater detail by reference to the attached drawings which show an example form of the invention. It is to be understood that the particularity of those drawings does not supersede the generality of the preceding description of the invention.

### BRIEF DESCRIPTION OF THE DRAWINGS

FIG. 1 shows a hand held device according to an embodiment of the invention;

FIG. 2 shows components of the embodiment of FIG. 1 and their functional interrelationships;

FIG. 3 is an illustration of a graphical user interface menu for use in an embodiment of the invention;

FIG. 4 shows a mathematical function selection menu for use in an embodiment of the invention;

FIG. 5 presents a table of available types of predefined equations for use in an embodiment of the invention;

FIG. 6 shows an editing page for a symbolic representation for use in an embodiment of the invention;

FIG. 7-1 to 7-3 illustrate a manipulation of multiple representations of a mathematical relationship using a translation manipulation;

FIG. 8-1 to 8-3 illustrate the selection and manipulation of multiple representations of a mathematical relationship using a dilation manipulation;

FIG. 9 is a functional flow diagram for application software for use in an embodiment of the invention.

### DETAILED DESCRIPTION OF THE INVENTION

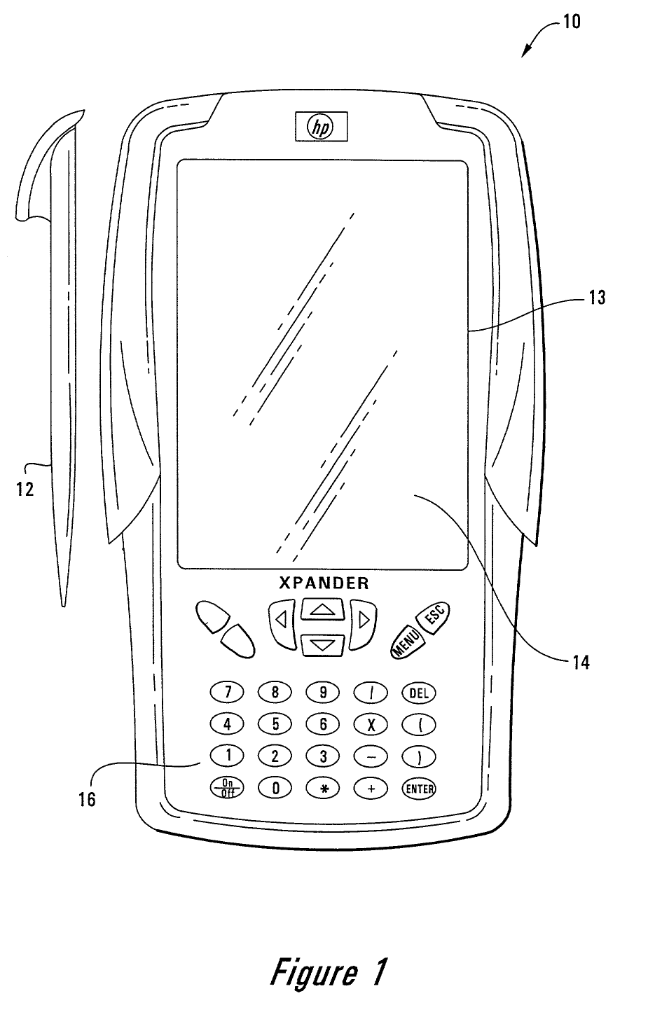

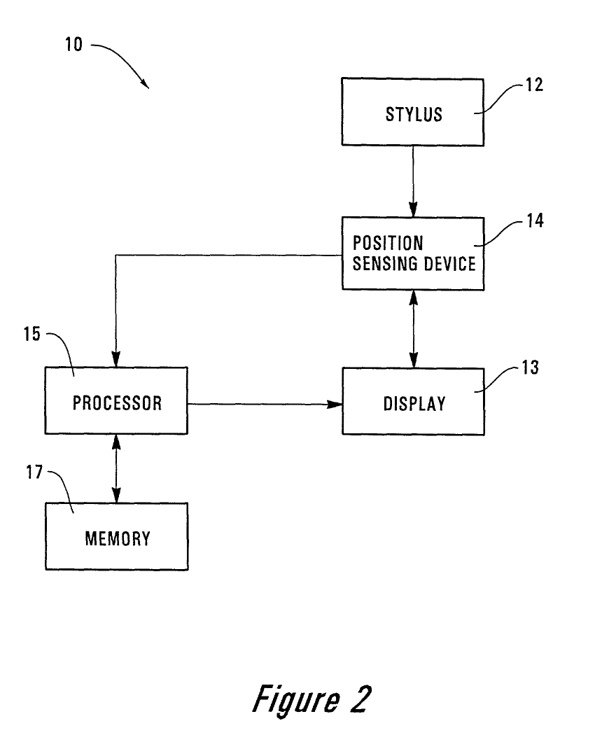

The invention is preferably realised in a hand held device 10 as illustrated in FIG. 1. This device 10 includes a visual display device 13 and an associated position sensitive device 14, that is a touch screen visual display 13-14, and a stylus 12. With reference also to FIG. 2, the device 10 includes a processor 15 operatively linked with the touch screen visual display 13-14 and a memory 17 for storing application software, data and visual display information. The position sensing device 14 detects movement of the stylus 12 over the display 13 surface. The device 10 includes a user interface keypad 16 in addition to a graphical user interface (GUI) via use of the stylus 12 on the touch screen 13-14.

According to the method aspect of the invention, multiple representations (which include a graphical representation) of a mathematical relationship are updated substantially simultaneously and correspondingly with a user controlled manipulation of any one of the multiple representations of the mathematical relationship. It is to be appreciated that, whilst the following description describes the selection, display and manipulation of multiple representations of a single mathematical relationship, the present invention is not limited to this capability. Indeed, the present invention is equally capable of providing multiple representations of multiple mathematical relationships contemporaneously, wherein each of the multiple representations may be able to be manipulated and displayed in accordance with the method of the present invention.

In the preferred embodiment of the present invention, as illustrated in FIG. 1, when the hand held device 10 is powered on, the display 13 presents the user with a workbook environment from which the user is able to select and activate the application software.

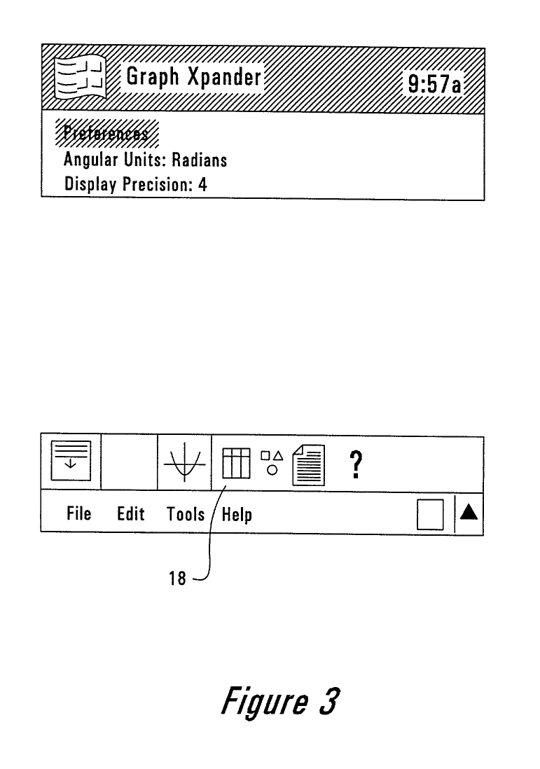

Upon activation of the application software, the hand held device 10 displays an interactive, menu driven graphical user interface (GUI) as illustrated in FIG. 3. The GUI provides the user with access to configuration information and the capability to select and control functional modes (for example, an active stylus mode, display mode, help) of the present invention. In the preferred embodiment of the invention, the GUI may also include button ‘icons’ 18 which enable a user to select and control functional modes via the activation of a particular button icon.

A first mode of operation of the hand-held device 10 (‘the selection mode’) enables a user to specify a type of mathematical function for manipulation. In this respect, the selection mode enables a user to specify the desired mathematical function by either specifying a particular function (‘a user defined function’) or constructing an equation from a list of predefined equation types (‘a predefined equation’).

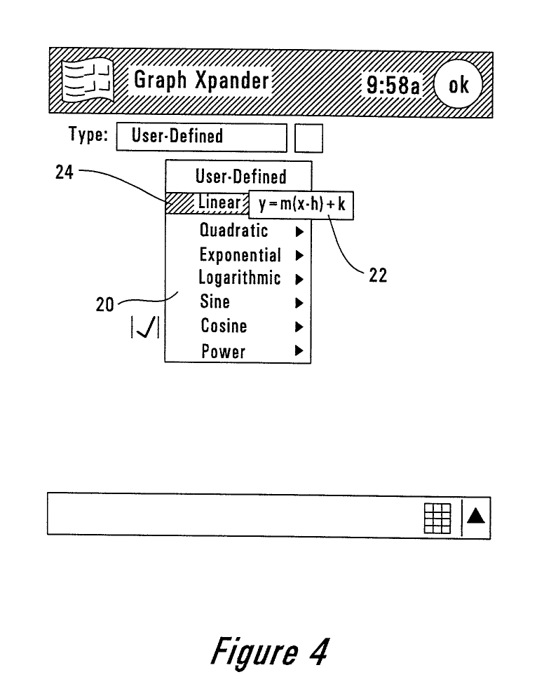

When the selection mode is enabled, as is illustrated in FIG. 4, a user is presented with a plurality of predefined equation types 20, from which the user is able to select an equation type. In this respect the available equation types include:

| | |
|---|---|
| (a) | user defined; |
| (b) | linear; |
| (c) | quadratic; |
| (d) | exponential; |
| (e) | logarithmic; |
| (f) | sine; |
| (g) | cosine; and |
| (h) | power. |

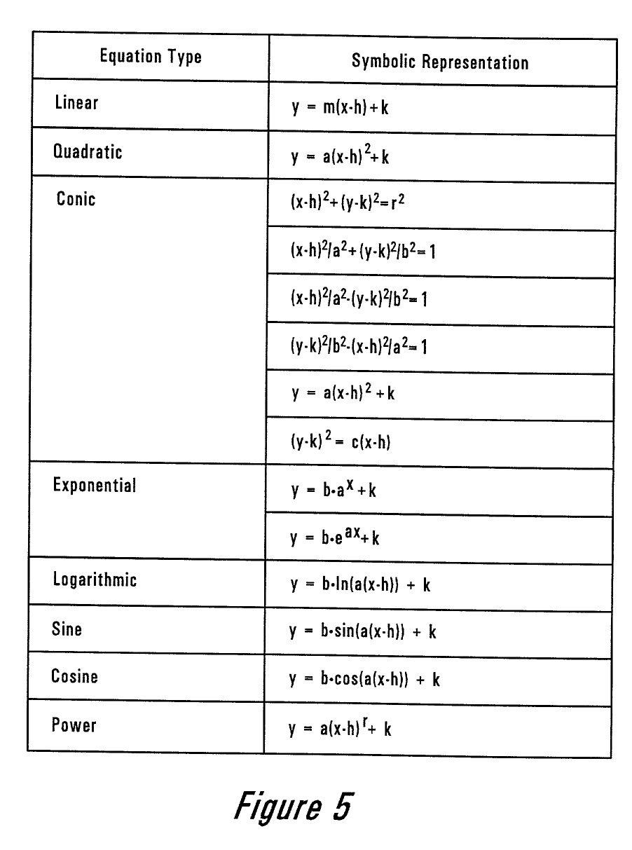

During the process of selecting a desired equation type, the user is presented with a symbolic representation 22, or representations, of a particular mathematical equation, or equations, associated with a selected equation type 24. In this respect, since each equation type describes a generic category of mathematical equations, each equation type may be associated with multiple mathematical equations. Using the stylus 12, the user is able to select a desired mathematical equation from the available types of mathematical equations 20 associated with a selected equation type 24. In the preferred form of the present invention, the association between a particular equation type and the corresponding symbolic representations of a mathematical equation is as illustrated in FIG. 5.

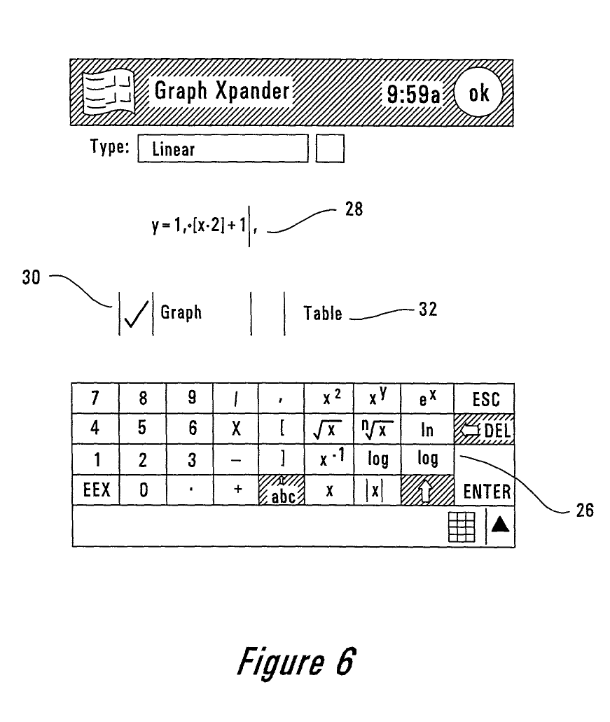

Once a mathematical equation 22 is selected, the user is able to edit parameters (for example algebraic coefficients) associated with the mathematical equation 22. Preferably, the user is also able to modify or incorporate mathematical operators. In this respect, the available types of mathematical operators are provided in a predetermined list of mathematical operators and numerical values 26 (see FIG. 6).

Having constructed the final form of the mathematical equation (see reference 28 in FIG. 6), the user is able to designate which representation of the mathematical equation will be in view on the display together with the symbolic representation of the selected mathematical equation. In this respect, the user is able to select either a graphical representation check box 30 or a numerical representation check box 32 to designate a representation of the mathematical equation (that is, either a graph, or a table, or both) to be displayed. Once the user has nominated the desired representation mechanism 30 or mechanisms, the user instructs the hand held device 10 to exit the selection mode.

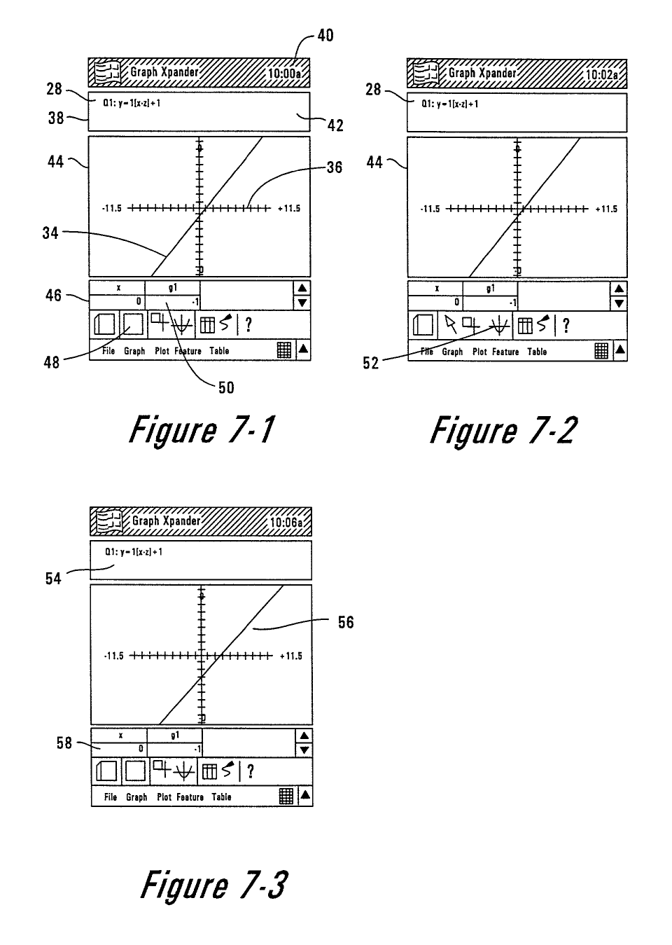

Upon exiting the selection mode, the hand held device 10 enters a second mode (‘the display mode’) whereby the selected mathematical equation 28 is viewable on the display 10 (see FIG. 7-1), in accordance with the selected representation 30 or representations. Thus FIG. 7-1 illustrates the resultant presentation on the display 13 of the selected equation 28 together with its corresponding graphical representation in the form of a graph 34 relative to a set of co-ordinate axes 36.

As is illustrated in FIG. 7-1, the arrangement of the resultant presentation consists of three ‘panes’. A first pane is a ‘symbolic pane’ 38 which contains the symbolic representation of the selected mathematical equation 28 and controls 40, 42 for selecting which other pane is a viewable pane. A second pane, herein referred to as the ‘graphical pane’ 44, contains the graph 34 of the selected mathematical equation 28. In the illustration shown, the ‘graphical pane’ 44 is illustrated as the primary pane, in accordance with the user selection made earlier (reference 30 of FIG. 6). A third pane, herein referred to as the ‘table pane’ 46 is also viewable. The sizes of the three panes are adjustable by horizontal “sashes” that can be moved up and down.

The graphical representation 30 is not able to be manipulated by the user until the user has ‘selected’ the graph and a mode of manipulation. The hand held device 10 provides a user with the following mechanisms to enable the selection of the graph:

(a) ‘tapping’ the stylus 12 on the relation icon 28;

(b) ‘tapping’ the stylus 12 on the ‘select’ button 48 and then tapping the stylus on the required graph 34;

(c) ‘tapping’ the stylus 12 on the heading of a column for an associated dependent variable in the table pane 46.

The above reference to the term ‘tapping’ is to be understood to be reference to an action by the user which involves placing the stylus 12 on the display surface of the touch screen display 13-14 to select a particular displayed object. The position of the stylus on the display surface is interpreted by the application software using position information (co-ordinate data) provided by the position sensing device 14. The application software compares co-ordinate data of displayed objects with co-ordinate data of the stylus 12 to determine whether the action of ‘tapping’ is associated with the selection of a particular displayed object. In the event that the ‘tapping’ is associated with a particular object, then the object is selected.

Once a graph 34 has been selected by a user, the selected graph is then able to be manipulated by the user, using the stylus 12. In the device 10, a graph 34 may be manipulated by either direct or indirect means.

Indirect manipulation involves manipulation of the graph 34 as a result of modifications to the selected mathematical equation 28. For example, if the user edits a coefficient in the selected mathematical equation 28, then the application software will substantially simultaneously and correspondingly regenerate the graph (and the tabular representation) in accordance with the changes to the mathematical equation.

Direct manipulation involves manipulation of the graph itself. Preferably at least two modes are provided for direct manipulation of a graph. These are:

(a) translation mode; and

(b) dilation mode.

Translation mode is that mode in which the user is able to shift a selected graph 34 with respect to co-ordinate axes 30. During a translation process, the size and shape characteristics of a selected graph 34 are maintained. As is illustrated in FIG. 7, the user can enable the translation mode by activating a button 52, thus selecting the translation mode. The user then places the stylus over the displayed graph 34 and ‘drags’ the stylus 12 across the surface of the touch screen display 13-14.

As the stylus 12 is being dragged across the display surface, the application software continuously samples the position of the stylus 12 on the surface of the touch screen display 13-14 using co-ordinate data provided by the position sensing device 14. The application software interprets movements in the stylus 12 position, processes the stylus motion, and correspondingly updates the graphical 34, symbolic 28 and numerical 46 representations in accordance with the stylus 12 motion. The process of updating the graphical, symbolic, and numerical representations occur substantially simultaneously. The design of the application software which supports the translation capability will be described in more detail below.

Once the graph 34 has been moved to a desired position (compare FIGS. 7-1, 7-2 and 7-3), the user lifts the stylus 12 off of the touch screen surface 13-14, thus completing the translation process. FIG. 7-3 illustrates an updated symbolic representation 54, an updated graphical representation 56 and an updated numerical data 58 as a result of the translation process described above.

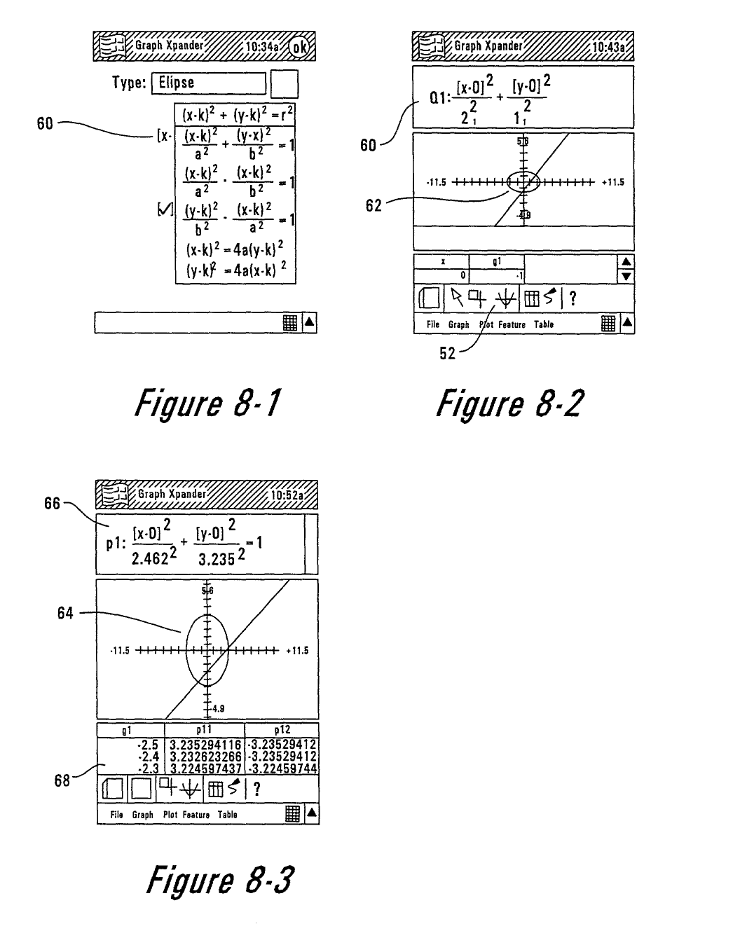

Dilation mode is that mode in which the user is able to ‘shrink’ or ‘stretch’ the selected graph with respect to a particular point in the coordinate plane. An example of the application of a dilation manipulation to a selected mathematical equation is illustrated in FIGS. 8-1 to 8-3. As is illustrated in FIG. 8-1 a user firsts constructs a mathematical equation 60 for display in the form of a representational graph using a similar process to that described earlier.

FIG. 8-2 illustrates the corresponding graphical representation 62 for the selected mathematical equation 60. As is illustrated in FIG. 8-2, after the graphical representation has been selected, the user is able to instruct the hand held device 10 to enter dilation mode by activating the control 52, and enabling dilation mode. Once dilation mode has been selected, the stylus 12 is placed on the surface of touch screen display 13-14 and ‘dragge’ across the display. Using a process which will be described in more detail later, the application software detects and processes the stylus motion, and in response regenerates the graphical, symbolic and numerical representations of the mathematical relationship. FIG. 8-3 illustrates the result of a dilation operation performed on an elliptical mathematical relationship showing the updated graphical 64, symbolic 66 and numerical 68 representations of the mathematical relationship.

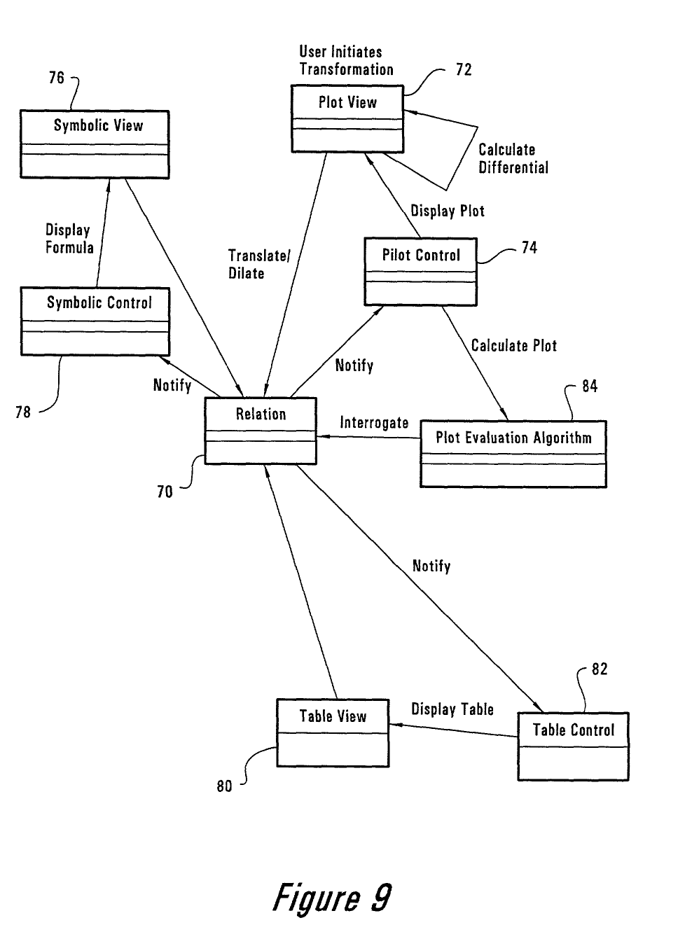

FIG. 9 illustrates the preferred architecture of the application software. The software architecture in FIG. 9 is representative of the multi-representational approach used to display three views of a single underlying mathematical relationship. Thus FIG. 9 indicates the three GUI classes used for a mathematical relationship as a symbolic view 76 (that is, an equation expressed in terms of standard mathematical nomenclature), a plot view 72 (that is, a graphical representation) and a table view 80 (that is, a numerical representation in the form of a table of values).

As is illustrated in FIG. 9, the software architecture consists of a number of software components which are interconnected using a particular interface arrangement. A Relation software component 70 stores the mathematical equation which is represented in the mathematical relations shown in the symbolic pane 38, the graphical pane 44 and the table pane 46.

A PlotView software component 72 is responsible for the display of the representational graph of a stored mathematical equation and processing user manipulation which occurs in the graphical pane 44 (in the form of stylus user manipulation which occurs in the graphical pane 44 (in the form of stylus position data). The PlotView software component 72 interfaces with a PlotControl software component 74 and the Relation software component 70. Here, the PlotView software component 72 is able to detect user manipulation of a representational graph and pass user manipulation information to the Relation software component 70. Subsequent to the execution of a processing algorithm, the PlotView software component 72, SymbolicView software component 76 and TableView software 80 component receive notifications about changes in the relations from the corresponding controller software component 74, 78, 82 respectively, to enable regeneration of the corresponding view.

The SymbolicView software component 76 is responsible for the display of the symbolic representation of a stored mathematical equation and processing user input which occurs in the symbolic pane (for example, editing of the mathematical equation). As is illustrated in FIG. 9, the SymbolicView software 76 interfaces with the SymbolicControl component 78 and the Relation software component 70. Here, the SymbolicView software component 76 is able to detect user modification of the symbolic representation of a mathematical equation and pass that information to the Relation software component 70. Subsequent to the execution of a processing algorithm, the PlotView software component 72, SymbolicView software component 76 and TableView software component 80 receive notifications about changes in the relations from the corresponding controller software component 74, 78, 82 respectively, to enable regeneration of the corresponding view.

The TableView software component 80 is responsible for the display of the numerical representation of a stored mathematical equation and processing user input which occurs in the table pane (for example, editing of the table). As is illustrated in FIG. 9, the TableView software component 80 interfaces with the TableControl component 82 and the Relation software component 70. Here, the TableView software component 82 is able to detect user modification of the numerical representation of a mathematical equation, however this modification does not change the relation. That is, within the table, the user can only make changes that affect the values displayed in the table view itself.

The PlotView Algorithm is a collection of mathematical rules and procedures used to produce efficiently outputs for a particular relation over the domain of values on the representational graph. In this respect, each relation has its own dedicated algorithm.

In response to a user initiating a command to translate or dilate a graphical representation of a mathematical relation the application software performs the following sequence of steps:

1. The PlotView software 72 determines the type of manipulation (based on the active stylus tool) and the associated parameters (based on stylus motion) of that manipulation.

2. The PlotView 72 sends a manipulation request, together with the associated parameters (for example, translate 0.3 units horizontally and 0.1 units vertically) to the Relation Software 70.

3. The Relation Software 70 notifies the PlotController 74, a SymbolicControl 78 and TableControl 82 of the manipulation.

4. The PlotControl 74 uses a Plot Evaluation Algorithm 84 to recalculate the plot.

5. The Plot Evaluation Algorithm 84 interrogates the Relation Software 70 for information required (for example, the parameters of the mathematical relationship) to evaluate the plot.

6. Once the plot is calculated the PlotConrol 74 sends a new graphical representation to the PlotView 72 for display.

7. The SymbolicControl 78 calculates the relation for the symbolic view and sends it to the SymbolicView 76 for display.

8. The TableControl 82 calculates the relation for the table view and sends it to the TableView 80 for display.

The application software similarly provides for initiation from the SymbolicView 76, but not the TableView 80.

When the hand held device 10 is operating in translation or dilation mode, and a graph has been selected, the process of recalculating and regenerating the multiple representations of the mathematical relationship is repeated continuously whilst the stylus 12 is in contact with the surface of the touch screen display 13-14. Preparation of suitable application software to provide the above described functioning is well within the capability of a skilled computer programmer.

An alternative embodiment may provide for a user to define the mathematical equation by inputting desired information to construct the mathematical equation instead of selecting from a list of predefined relation types. In this case the system will include software for identifying a user-entered relation (mathematical equation) as fitting into one of a list of predefined relation types after the relation is entered.

The invention described herein is susceptible to variations, modifications and/or additions other than those specifically described and it is to be understood that the invention includes all such variations, modifications and/or additions that fall within the spirit and scope of the following claims.

1. An interactive method for demonstrating an interrelationship between different representations of a mathematical relationship, including the steps of:
(a) defining a mathematical equation;
(c) simultaneously displaying at least two of multiple representations of the defined mathematical equation, wherein the available types of multiple representations include a graphical representation in the form of a graph, a numerical representation in the form of a table of values, and a symbolic representation in the form of an equation expressed in terms of standard mathematical nomenclature, wherein one of the displayed representations is the graphical representation;
(c) manipulating the graphical representation; and
(d) processing the manipulation to substantially simultaneously and correspondingly update the other displayed representation of the mathematical relationship in accordance with the manipulation of the graphical representation,
whereby a user of the method is able to substantially immediately observe the effect of changes made to the graphical representation via its manipulation on the other of the at least two displayed representations.

2. A method as claimed in claim 1 wherein the step of defining a mathematical equation includes selecting a mathematical equation from a list of predefined mathematical equations.

3. A method as claimed in claim 2 wherein the list of predefined mathematical equations includes equations selected from one or more of:
(a) linear mathematical relations;
(b) polynomial mathematical relations;
(c) exponential mathematical relations;
(d) logarithmic mathematical relations;
(e) power mathematical relations;
(f) trigonometric mathematical relations; and
(g) conic section mathematical relations.

4. A method as claimed in claim 2 wherein the list of predefined mathematical equations includes at least two equations selected from::
(a) a linear mathematical equation described by y=m(x−h)+k;
(b) a quadratic mathematical equation described by y=a(x−h)²+k;
(c) a circular mathematical equation described by (x−h)²+(y−k)²=r²;
(d) an elliptical mathematical equation described by
$$\frac{{( x - h )}^{2}}{{a}^{2}} + \frac{{( y - k )}^{2}}{{b}^{2}} = 1 ;$$
(e) a hyperbolic mathematical equation described by
$$\frac{{( x - h )}^{2}}{{a}^{2}} - \frac{{( y - k )}^{2}}{{b}^{2}} = 1 ;$$
(f) a hyperbolic mathematical equation described by
$$\frac{{( y - k )}^{2}}{{b}^{2}} - \frac{{( x - h )}^{2}}{{a}^{2}} = 1 ;$$
(g) a parabolic mathematical equation described by y=m(x−h )²+k;
(h) a parabolic mathematical equation described by (y−k²)=c(x−h);
(i) a general exponential mathematical equation described by y=ba^{x}+k;
(j) a natural exponential mathematical equation described by y=be^{ax}+k;
(k) a logarithmic mathematical equation of the form y=b1n(a(x−h))+k;
(l) a power mathematical equation described by y=a(x−h)^{r}+k;
(m) a sine mathematical equation described by y=bSin(a(x−h))+k; and
(n) a cosine mathematical equation described by y=bCos(a(x−h))+k;
where x and y are variable parameters and a, b, m, h, k and r are parameters according to standard mathematical nomenclature, the numerical values for which included in a particular predefined mathematical relation are user definable.

5. A method as claimed in claim I wherein manipulation mechanisms available for manipulating the graphical representation of the mathematical relation include:
(a) translating the graph with respect to a set of coordinate axes; and
(b) dilating the graph with respect to a set of coordinate axes.

6. A method as claimed in claim 1 wherein the method is performed using a programmed computer in combination with a stylus device.

7. An interactive method for demonstrating an interrelationship between representations of a mathematical relationship, one of which representations is a graphical representation of the relationship relative to co-ordinate axes, the method including:
(a) simultaneously displaying on a visual display a mathematical relation in the form of the graphical representation and in another format being either an algebraic formula or a tabulated set of data which describes the graph or both;
(b) locating a stylus on the graphical representation on a position sensing screen associated with the visual display and a processor for the position sensing device to sense stylus position and provide stylus position data to the processor;
(c) moving the stylus over the position sensing screen for the processor to process changing stylus position data and manipulate the displayed graphical representation to change its shape or position relative to the co-ordinate axes in accordance with the motion of the stylus over the position sensing screen;
(d) wherein displayed information in said another format is substantially simultaneously and correspondingly changed to continually describe the graph as it is manipulated;
whereby a user of the method is able to substantially immediately observe the effect of changes made to the graphical representation via its manipulation on said another of the displayed representations.

8. Apparatus for interactively demonstrating an interrelationship between different representations of a mathematical relation, the apparatus including
a visual display device and a position sensitive touch screen associated with the visual display device, a processor operatively linked with the visual display device and the touch screen, and a memory for storing application software, data and visual display information for the processor, visual display device and touch screen;
the visual display device and position sensitive touch screen providing for definition by use of a stylus of a mathematical equation;
wherein the visual display device simultaneously displays at least two of multiple possible representations of the defined mathematical equation, the multiple possible representations including a graphical representation in the form of a graph, a numerical representation in the form of a table of relation values, and a symbolic representation in the form of an equation expressed in terms of standard mathematical nomenclature,
and wherein the graphical representation is selectable for display as one of said at least two displayed representations;
wherein a stylus is positionable on the touch screen on the graphical representation and movable over the touch screen to generate changing position data, the apparatus being responsive to said changing position data for the visual display device to display in real time a manipulation of the graphical representation corresponding to the movement of the stylus;
and wherein the apparatus is also responsive to said changing position data to substantially simultaneously and correspondingly update the other displayed representation of the mathematical relationship in accordance with the manipulation of the graphical representation; whereby a user is able to substantially immediately observe the effect of changes made to the graphical representation via its manipulation on the other of the at least two displayed representations.

9. Apparatus as claimed in claim 8 wherein the visual display device and position sensitive touch screen provide for selection of a mathematical equation from a list of predefined mathematical equations stored in the memory whereby the mathematical equation is definable.

10. Apparatus as claimed in claim 9 wherein the list of predefined mathematical equations stored in the memory includes equations selected from one or more of:
(a) linear mathematical relations;
(b) polynomial mathematical relations;
(c) exponential mathematical relations;
(d) logarithmic mathematical relations;
(e) power mathematical relations;
(f) trigonometric mathematical relations; and
(g) conic section mathematical relations.

11. Apparatus as claimed in claim 9 wherein the list of predefined mathematical equations stored in the memory includes at least two equations selected from:
(a) a linear mathematical equation described by y=m(x−h)+k;
(b) a quadratic mathematical equation described by y=a(x−h)²+k;
(c) a circular mathematical equation described by (x−h)²+(y−k)²=r²;
(d) an elliptical mathematical equation described by
$$\frac{{( x - h )}^{2}}{{a}^{2}} + \frac{{( y - k )}^{2}}{{b}^{2}} = 1 ;$$
(e) a hyperbolic mathematical equation described by
$$\frac{{( x - h )}^{2}}{{a}^{2}} - \frac{{( y - k )}^{2}}{{b}^{2}} = 1 ;$$
(f) a hyperbolic mathematical equation described by
$$\frac{{( y - k )}^{2}}{{b}^{2}} - \frac{{( x - h )}^{2}}{{a}^{2}} = 1 ;$$
(g) a parabolic mathematical equation described by y=m(x−h)²+k;
(h) a parabolic mathematical equation described by (y−k²)=c(x−h);
(i) a general exponential mathematical equation described by y=ba^{x}+k;
(j) a natural exponential mathematical equation described by y=be^{ax}+k;
(k) a logarithmic mathematical equation of the form y=b1n(a(x−h))+k;
(l) a power mathematical equation described by y=a(x−h)^{r}+k;
(m) a sine mathematical equation described by y=bSin(a(x−h))+k; and
(n) a cosine mathematical equation described by y=bCos(a(x−h))+k;
where x and y are variable parameters and a, b, m, h, k and r are parameters according to standard mathematical nomenclature, the numerical values for which included in a particular predefined mathematical relation are user definable.

12. Apparatus as claimed in claim 8 wherein the application software provides manipulation mechanisms for manipulating the graphical representation of the mathematical equation which include
(a) translating the graph with respect to a set of coordinate axis;
(b) dilating the graph with respect to a set of coordinate axis.

13. Apparatus as claimed in claim 8 which is a hand-held computer device.

14. A hand held computer device for demonstrating an interrelationship between different representations of a mathematical relationship, including
(a) a visual display unit for displaying multiple representations of a mathematical relationship, wherein the available representations include:
(i) a graphical representation,
(ii) a numerical representation in the form of tabulated data, and
(iii) a symbolic representation in the form of a mathematical equation;
(b) a memory for storing application software, data, and visual display information;
(c) a stylus;
(d) a position sensing touch screen associated with the visual display unit; and
(e) a processor coupled to the visual display unit, memory, and position sensing device touch screen, for updating multiple representations of the mathematical relationship according to a manipulation of a graphical representation displayed on the visual display unit, wherein the manipulation of the graphical representation occurs in response to a motion of the stylus on the position sensing touch screen; whereby a user of the device is able to substantially immediately observe the effect of changes made to the graphical representation via its manipulation on the other of the at least two displayed representations.
